(19) United States
(12) Patent Application Publication
(10) Pub. No.: US 2008/0225689 A1
(43) Pub. Date: Sep. 18, 2008

(54) Orthogonal frequency division multiplexing having tones with overlaid data and pilot symbols

(76) Inventors: Mark A. Bickerstaff, Carlingford (AU); Yunxin Li, Ryde (AU)

Correspondence Address: MENDELSOHN & ASSOCIATES, P.C., 1500 JOHN F. KENNEDY BLVD., SUITE 405, PHILADELPHIA, PA, 19102, US

(21) Appl. No.: 11/717,540

(22) Filed: Mar. 13, 2007

(51) Int. Cl. H04J 11/00

(52) U.S. Cl. 370/208

(57) ABSTRACT

In one embodiment, an OFDM transmitter generates sets of frequency-domain data symbols from a stream of digital data. For each set of frequency-domain data symbols generated, the transmitter generates a corresponding set of frequency-domain pilot symbols. Each corresponding set of data symbols and pilot symbols are then multiplexed onto a set of frequency tones, such that, at least one tone is occupied by both a data symbol and a pilot symbol. For each tone having both a pilot symbol and data symbol, the pilot symbol and data symbol are added together to form an overlaid data and pilot (ODP) tone. Each set of tones having at least one ODP tone is then transmitted to an inverse fast Fourier transform (IFFT) processor that transforms each set of tones into an ODP OFDM symbol. Each ODP OFDM symbol is then prepared for transmission using digital-to-analog conversion, cyclic prefix insertion, and RF modulation.

### BACKGROUND OF THE INVENTION

1. Field of the Invention

The present invention relates to signal processing, and more specifically, to orthogonal frequency division multiplexing techniques used in signal transmission and reception.

2. Description of the Related Art

Orthogonal frequency division multiplexing (OFDM) is a signal processing technology well known in the field of communications. In general, OFDM operates by dividing a frequency spectrum into smaller frequency bands (a.k.a., tones) and modulating the bands with parts of a data signal.

FIG. 1 shows a simplified block diagram of one implementation of a prior-art OFDM transmitter 100. Transmitter 100 receives data signals and converts these signals into analog OFDM symbols. Conversion of the data signals occurs through steps of serial-to-parallel (S/P) conversion 104, base-band modulation 106, pilot symbol generation 108, multiplexing 110, inverse fast Fourier transform (IFFT) processing 112, cyclic prefix insertion (CPI) 114, digital-to-analog (D/A) conversion 116, and radio-frequency (RF) modulation 118. After conversion, transmitter 100 transmits each OFDM symbol during time interval iT_{OFDM} to (i+1) T_{OFDM} where i identifies the particular OFDM symbol and T_{OFDM} represents the duration of each OFDM symbol.

S/P converter 104 converts a serial bit stream of digital data received from a data source 102 into D parallel bit streams. Base-band modulator 106 modulates each bit stream into a separate frequency-domain symbol stream. In particular, for each bit stream, base-band modulator 106 converts each set of one or more data bits into a data symbol represented as a complex number. Depending on the implementation, base-band modulator 106 performs any of a number of techniques commonly known in the art, including but not limited to phase-shift-keying (PSK) and quadrature amplitude modulation (QAM).

For each set of D parallel data symbols generated by base-band modulator 106, pilot symbol generator 108 generates a set of P parallel, predefined, frequency-domain pilot symbols, wherein each pilot symbol is represented as a complex number. Generation of the sets of parallel pilot symbols may be performed using any of a number of methods commonly known in the art. For example, in one such method, pilot symbol generator 108 uses a binary [−1, +1] or quaternary [−1, +1, −j, +j] signal set and assigns each of the P pilot symbols to one element of the signal set. Each set of D parallel data symbols and each corresponding set of P parallel pilot symbols are then transmitted to multiplexer 110.

Multiplexer 110 multiplexes each corresponding pair of sets of D parallel data symbols and P parallel pilot symbols to generate a set of parallel frequency-multiplexed data and pilot (FMDP) symbols. Multiplexing is performed by assigning each data/pilot symbol in a corresponding pair of sets to a different frequency band (i.e., tone) in a set of frequency bands, such that each band will be modulated by either a data symbol or a pilot symbol but not both. As such, each set of FMDP symbols comprises (D+P) complex numbers.

IFFT processor 112 transforms each set of FMDP symbols into an OFDM symbol i. Each transformation is based on a set of N frequency-domain complex numbers, where N comprises D data symbols, P pilot symbols, and G unused (e.g., guard) tone locations (i.e., N=D+P+G). For each transformation, IFFT processor 112 outputs an OFDM symbol i comprising a set of N time-domain complex numbers.

FIG. 2 graphically illustrates one possible arrangement of pilot symbols and data symbols onto tones of a prior-art FMDP OFDM symbol i. As shown, each pilot symbol, represented as a solid arrow, occupies a tone location different from that of each data symbol, represented as a dashed arrow. According to alternative embodiments, the location and quantity of both the pilot symbols and data symbols may vary. Moreover, in other embodiments, an OFDM symbol i may contain one or more guard tone locations.

Referring again to FIG. 1, each FMDP OFDM symbol i is then prepared for transmission. First, cyclic prefix inserter 114 inserts a cyclic prefix onto each FMDP OFDM symbol i, wherein the cyclic prefix is used to reduce errors due, e.g., to channel dispersion. Each cyclic prefix, represented by C complex numbers, is added to a set of N time-domain complex numbers to generate a set of M complex numbers (i.e., M=N+C). D/A converter 116 then converts each set of M complex numbers from digital to analog format. Next, RF modulator 118 shifts each analog FMDP OFDM signal i to a desired frequency for transmission. Note that the use of cyclic prefix inserter 114 and RF modulator 118 is optional, and therefore, they might not be employed in some prior-art OFDM transmitters.

In addition to the FMDP OFDM symbols described above, transmitter 100 also generates and transmits synchronization (SYNC) OFDM symbols. The SYNC OFDM symbols are generated using a predetermined sequence of bits known by the receiver, and do not transmit user data. These symbols are used by the receiver to establish the timing for each OFDM frame (e.g., for synchronization). In practice, the SYNC OFDM symbols are time-multiplexed with the FMDP OFDM symbols as shown in FIG. 3.

FIG. 3 shows a simplified representation of one embodiment of a prior-art OFDM transmission. A SYNC OFDM symbol is inserted periodically before a set of one or more FMDP OFDM symbols, thereby establishing the beginning of an OFDM frame. In this embodiment, two OFDM frames are shown and each frame comprises one SYNC OFDM symbol and two FMDP OFDM symbols. In other implementations, the number of SYNC OFDM symbols and FMDP OFDM symbols may vary. The OFDM frames are then transmitted over any one of a number of transmission media, including but not limited to airwaves, fiber optics, and coaxial cables.

FIG. 4 shows a simplified block diagram of one implementation of a prior-art OFDM receiver 400, which reverses the operations performed by OFDM transmitter 100. Receiver 400 receives analog OFDM signals and extracts the originally transmitted data. Extraction occurs through steps of radio-frequency (RF) demodulation 402, analog-to-digital (A/D) conversion 404, frame synchronization 406, cyclic prefix removal (CPR) 408, fast Fourier transform (FFT) processing 410, channel estimation 412, filtering 414 and base-band demodulation 416.

RF demodulator 402 down-converts the received OFDM signal into a base-band analog signal. The base-band analog signal is then converted to digital format by A/D converter 404 and transmitted to frame synchronizer 406. Frame synchronizer 406 establishes the timing of each OFDM frame by maximizing the correlation between the received SYNC OFDM symbols and the expected SYNC OFDM symbols known by receiver 400. Cyclic prefix remover 408 removes the cyclic prefix from each time-domain OFDM symbol i. Note that cyclic prefix remover 408 and RF demodulator 402 are not needed if the transmitter does not employ a cyclic prefix inserter and an RF modulator, respectively.

FFT processor 410 converts each time-domain OFDM symbol i into a set of N frequency-domain complex numbers yᵢ(j), where each complex number yᵢ(j) represents a received value corresponding to a frequency tone j. Each received value yᵢ(j) is a function of a data symbol dᵢ(j) or a pilot symbol pᵢ(j), a channel gain hᵢ(j), and channel noise nᵢ(j) as shown in Equations (1) and (2) below:

yᵢ(j)=pᵢ(j)×hᵢ(j)+nᵢ(j) (1)

yᵢ(j)=dᵢ(j)×hᵢ(j)+nᵢ(j). (2)

Each received value yᵢ(j) is then provided to both channel estimator 412 and equalizer filter 414.

Channel estimator 412 estimates the channel gain hᵢ(j) of each received value yᵢ(j). For each tone carrying a pilot symbol, the received value yᵢ(j) is compared to an expected pilot symbol pᵢ(j) known by receiver 400 to generate a channel gain estimate h̅ᵢ(j). For each tone carrying a data symbol, the transmitted data symbol dᵢ(j) is not known by receiver 400. Therefore, the channel gain hᵢ(j) for each tone carrying a data symbol is estimated by interpolating channel gain estimates h̅ᵢ(j) of the pilot symbols pᵢ(j). The channel gain estimates h̅ᵢ(j) are provided to equalizer filter 414.

Equalizer filter 414 filters complex numbers yᵢ(j) using the channel gain estimates h̅ᵢ(j) to obtain an equalized value for each complex number yᵢ(j). The equalized values are then demodulated by base-band demodulator 416, which performs demodulation corresponding to the modulation of base-band modulator 106 to obtain likelihood estimates for each data symbol dᵢ(j). The likelihood estimates are then provided to data sink 418, which might include processing such as symbol estimation, or other processing for recovering one or more output data bit streams from the received signal.

By modulating data symbols and pilot symbols onto separate tones, receiver 400 can estimate the channel gain hᵢ(j) of each received tone relatively easily using the method described above. For severely frequency-selective tones, where the channel gains vary significantly from tone to tone, channel estimation can be improved by increasing the number of pilot symbols. However, each separate pilot-carrying tone occupies bandwidth that could be used for transmitting data. This reduction in data bandwidth results in decreased data throughput of the OFDM system. In applications such as the Multi-band OFDM Alliance (MBOA) WiMedia Ultra-Wideband (UWB) application, the separate pilot-carrying tones can reduce the overall data throughput by as much as ten percent.

### SUMMARY OF THE INVENTION

In one embodiment, the present invention is a method for encoding data using orthogonal frequency division multiplexing (OFDM) modulation based on a set of OFDM tones. The method comprises (a) generating a set of one or more data symbol values; (b) generating a set of one or more pilot symbol values; and (c) applying OFDM modulation to the set of one or more data symbol values and the set of one or more pilot symbol values to generate an OFDM symbol in which at least one of the OFDM tones corresponds to both a data symbol value and a pilot symbol value.

In another embodiment, the present invention is an apparatus for generating an OFDM symbol based on a set of OFDM tones. The apparatus comprises (a) a data symbol generator adapted to generate a set of one or more data symbol values; (b) a pilot symbol generator adapted to generate a set of one or more pilot symbol values; and (c) an OFDM modulator adapted to apply OFDM modulation to the set of one or more data symbol values and the set of one or more pilot symbol values to generate an OFDM symbol in which at least one of the OFDM tones corresponds to both a data symbol value and a pilot symbol value.

In yet another embodiment, the present invention is a method for decoding a time-domain OFDM symbol having a set of OFDM tones. The method comprises (a) applying OFDM demodulation to the time-domain OFDM symbol to recover one or more frequency-domain demodulated symbol values encoded in the OFDM symbol, wherein at least one frequency-domain demodulated symbol value corresponds to both a data symbol value and a pilot symbol value; and (b) recovering one or more data values from the one or more frequency-domain demodulated symbol values.

In yet a further embodiment, the present invention is an apparatus for recovering data from a time-domain OFDM symbol having a set of OFDM tones. The apparatus comprises (1) an OFDM demodulator adapted to apply OFDM demodulation to the time-domain OFDM symbol to recover one or more frequency-domain demodulated symbol values encoded in the time-domain OFDM symbol, wherein at least one frequency-domain demodulated symbol value corresponds to both a data symbol value and a pilot symbol value; and (2) a data symbol demodulator adapted to recover the one or more data values from the one or more frequency-domain demodulated symbol values.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows a simplified block diagram of one implementation of a prior-art OFDM transmitter;

FIG. 2 graphically illustrates one possible arrangement of pilot symbols and data symbols onto tones of a prior-art OFDM symbol;

FIG. 3 shows a simplified representation of one embodiment of a prior-art OFDM transmission;

FIG. 4 shows a simplified block diagram of one implementation of a prior-art OFDM receiver;

FIG. 5 shows a simplified block diagram of an OFDM transmitter according to one embodiment of the present invention;

FIG. 6 graphically illustrates several possible arrangements of pilot symbols and data symbols onto tones of an OFDM symbol according to several embodiments of the present invention;

FIG. 7 shows simplified representations of an OFDM transmission according to two embodiments of the present invention;

FIG. 8 shows a simplified block diagram of an OFDM receiver according to one embodiment of the present invention;

FIG. 9 graphically illustrates an exemplary cluster, used for estimating channel gain, according to one embodiment of the present invention; and

FIG. 10 shows a simplified block diagram of an OFDM transmitter according to yet another embodiment of the present invention;

FIG. 11 shows a simplified block diagram of a pilot generator that may be used by the OFDM transmitter of FIG. 10 according to one embodiment of the present invention; and

FIG. 12 shows a simplified block diagram of a pilot generator that may be used by the OFDM transmitter of FIG. 10 according to another embodiment of the present invention.

### DETAILED DESCRIPTION

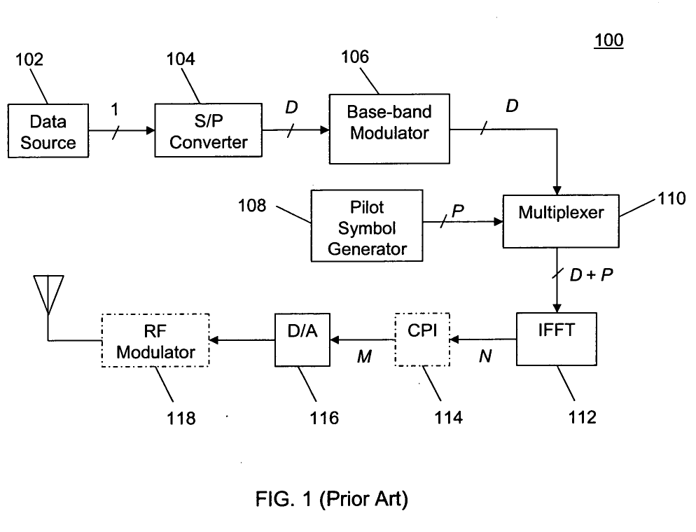

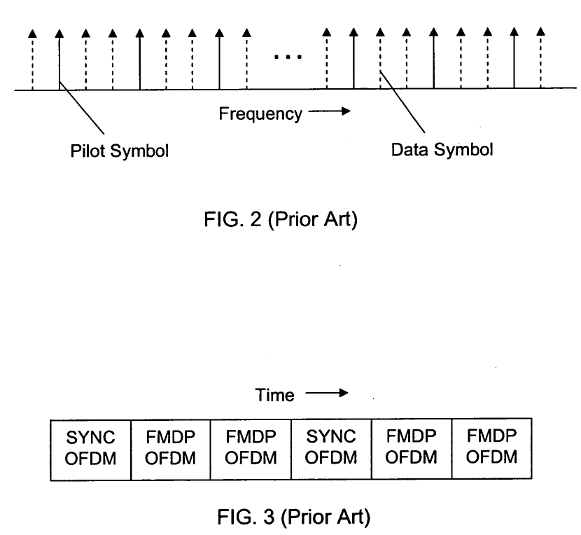

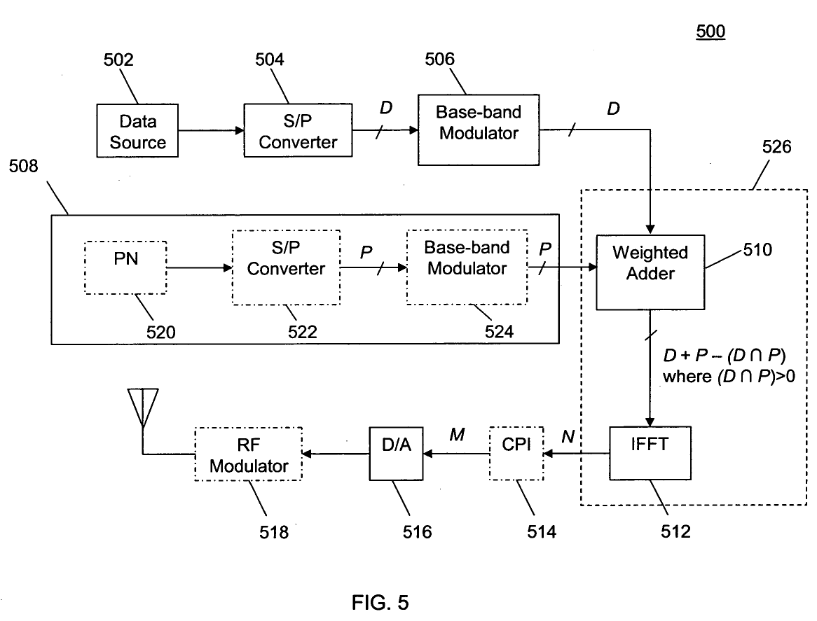

FIG. 5 shows a simplified block diagram of an OFDM transmitter 500 according to one embodiment of the present invention. Similar to transmitter 100 of FIG. 1, transmitter 500 receives data signals and converts these signals into analog OFDM symbols. Conversion occurs though steps of serial-to-parallel (S/P) conversion 504, base-band modulation 506, pilot symbol generation 508, OFDM modulation 526, cyclic prefix insertion (CPI) 514, digital-to-analog conversion 516, and radio-frequency (RF) modulation 518.

Serial-to-parallel (S/P) converter 504 and base-band modulator 506 perform operations analogous to those of S/P converter 104 and base-band modulator 106 of transmitter 100 to generate sets of D parallel data symbols, where each data symbol is represented as a complex number and D>1. Additionally, for each set of D data symbols, pilot symbol generator 508 generates P parallel pilot symbols, where each pilot symbol is represented as a complex number and P>1. Each set of D parallel data symbols and each corresponding set of P parallel pilot symbols are then provided to OFDM modulator 526.

OFDM modulator 526 comprises weighted adder 510 and inverse fast Fourier transform (IFFT) processor 512. Similar to multiplexer 110 of transmitter 100, weighted adder 510 assigns each corresponding pair of sets of D parallel data symbols and P parallel pilot symbols to a set of frequency bands (a.k.a., tones). However, instead of assigning each pilot symbol and each data symbol in a corresponding pair of sets to a different tone, weighted adder 510 assigns both a pilot symbol and a data symbol to at least one tone. For each tone having both a data symbol and a pilot symbol, the energy of the pilot symbol and/or data symbol on the tone may be scaled such that the energy of the pilot symbol is preferably significantly less than the energy of the data symbol. Additionally, for each tone having a data symbol or a pilot symbol, but not both, the energy of the data symbol or pilot symbol may optionally be scaled. Note that if the data symbols and pilot symbols are scaled prior to being received by weighted adder 510, weighted adder 510 may be a simple adder.

For each set of tones, weighted adder 510 sums the complex numbers on each tone to produce a set of tones having at least one tone with overlaid data and pilot (ODP) symbols. Each set of tones is then transmitted to IFFT processor 512, where the total number of tones in a set may be represented as the sum of the number D of data symbols and the number P of pilot symbols minus the number of tones that have both a data symbol and a pilot symbol (i.e., D+P−(D∩P)).

IFFT processor 512 transforms each set of tones into an ODP OFDM symbol i. Each transformation is based on a set of N frequency-domain complex numbers, where N comprises a set of tones received from weighted adder 510 and possibly, one or more (i.e., G), unused (a.k.a., guard) tone locations (i.e., N=D+P−(D∩P)+G). Each ODP OFDM symbol i generated comprises a set of N time-domain complex numbers.

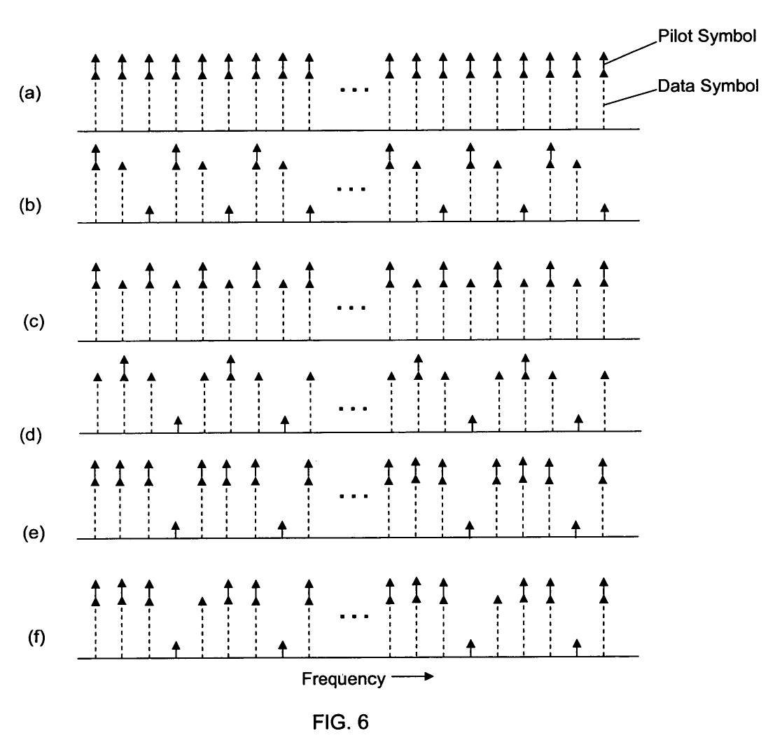

FIG. 6 graphically illustrates several possible arrangements of pilot symbols and data symbols onto tones of an OFDM symbol i according to several embodiments of the present invention. In FIGS. 6(a) through 6(f), each dashed arrow represents a data symbol and each solid arrow represents a pilot symbol. For simplicity, assume that each embodiment of FIG. 6 has the same number N of tones.

FIG. 6(a) shows one embodiment of the present invention in which the number D of data symbols is equal to the number P of pilot symbols (i.e., D=P). In this embodiment the number D of data symbols and the number P of pilot symbols are also equal to the number N of tones in the OFDM symbol i. Therefore, every tone is assigned both a data symbol and a pilot symbol. As such, the number of tones carrying data symbols and the number of tones carrying pilot symbols are maximized.

FIG. 6(b) shows another embodiment of the present invention in which the number D of data symbols is equal to the number P of pilot symbols. In this embodiment, however, the number D of data symbols and the number P of pilot symbols are less than the number N of tones in the OFDM symbol i, and thus, not every tone is assigned a data symbol and a pilot symbol. As shown, some tones are assigned a data symbol, some tones are assigned a pilot symbol, and some tones are assigned both a data symbol and a pilot symbol. Note that this embodiment transmits fewer pilot-carrying tones for training and fewer data-carrying tones than the embodiment of FIG. 6(a).

FIG. 6(c) shows one embodiment of the present invention in which the number D of data symbols is greater than the number P of pilot symbols (i.e., D>P). In this embodiment, the number D of data symbols is equal to the number N of tones in the OFDM symbol, and thus, every tone is assigned a data symbol. The number P of pilot symbols is less than the number N of tones, and thus, not every tone is assigned a pilot symbol. Compared to the embodiment of FIG. 6(a), this embodiment transmits the same number of data-carrying tones, but uses fewer pilot symbols for training.

FIG. 6(d) shows another embodiment of the present invention in which the number D of data symbols is greater than the number P of pilot symbols. In this embodiment, the number D of data symbols and the number P of pilot symbols is less than the number N of tones, and as a result, a data symbol and a pilot symbol are not both assigned to every tone. As shown, some tones are assigned a data symbol, some tones are assigned a pilot symbol, and some tones are assigned both a data symbol and a pilot symbol. In comparison to the embodiment of FIG. 6(c), this embodiment transmits fewer data-carrying tones and fewer pilot carrying tones.

FIG. 6(e) shows one embodiment of the present invention in which the number D of data symbols is less than the number P of pilot symbols (i.e., D<P). In this embodiment, the number P of pilot symbols is equal to the number N of tones in the OFDM symbol, and thus, every tone is assigned a pilot symbol. The number D of data symbols is less than the number N of tones, and thus not every tone is assigned a data symbol. In comparison to the embodiment of FIG. 6(a), this embodiment transmits the same number of pilot-carrying tones for training with fewer data-carrying tones.

FIG. 6(f) shows another embodiment of the present invention in which the number D of data symbols is less than the number P of pilot symbols. In this embodiment, the number D of data symbols and the number P of pilot symbols are less than the number N of tones, and thus, a data symbol and a pilot symbol are not both assigned to every tone. As shown, some tones are assigned a data symbol, some tones are assigned a pilot symbol, and some tones are assigned both a data symbol and a pilot symbol. In comparison to the embodiment of FIG. 6(e), this embodiment transmits the same number of data-carrying tones with fewer pilot-carrying tones for training.

Further embodiments of the present invention may be envisioned in which the number D of data symbols in a set generated by base-band modulator 506, the number P of pilot symbols in a set generated by pilot symbol generator 508, and the number N of tones in a set transformed by IFFT processor 512 may be different from one embodiment to another, and from one OFDM symbol i to the next. Additionally, each OFDM symbol i may have a number G of guard tones which were not included in the embodiments of FIG. 6(a) through 6(f). The location of the guard tones, data-carrying tones, and pilot-carrying tones may differ according to various embodiments of the present invention.

Referring again to FIG. 5, after IFFT processing 512, each OFDM symbol i is prepared for transmission by cyclic prefix inserter 514, D/A converter 516, and RF modulator 518, which perform operations analogous to those of the equivalent processing of prior-art transmitter 100. Note that cyclic prefix inserter 514 and RF modulator 518 are optional and might not be employed in some embodiments of the present invention. Each OFDM symbol is then transmitted over any one of a number of transmission media, including but not limited to airwaves, fiber optics, and coaxial cables.

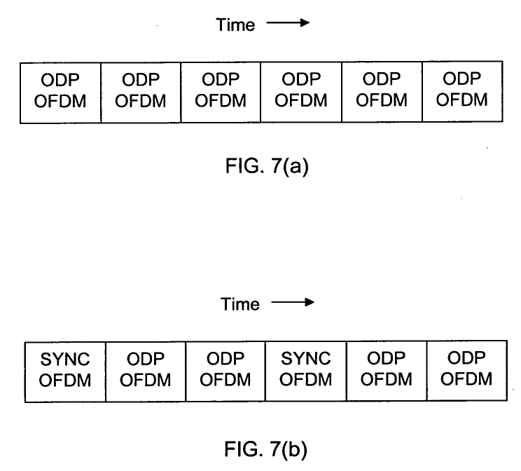

FIG. 7 shows simplified representations of an OFDM transmission according to two embodiments of the present invention. FIG. 7(a) shows one embodiment in which no synchronization (SYNC) OFDM symbols are transmitted. In this embodiment, the SYNC OFDM symbols are replaced by data carrying ODP symbols. FIG. 7(b) shows one embodiment in which SYNC symbols are transmitted. The SYNC OFDM symbols are inserted periodically before one or more ODP OFDM symbols, thereby establishing the beginning of each OFDM frame. In this implementation, each frame comprises one SYNC OFDM symbol and two ODP OFDM symbols. In other implementations, the number of SYNC OFDM symbols and ODP OFDM symbols may vary.

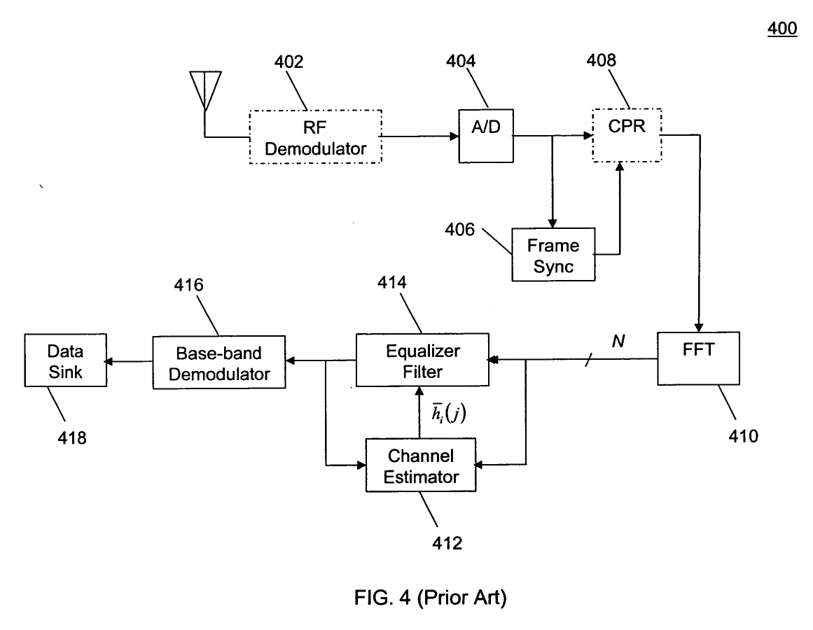

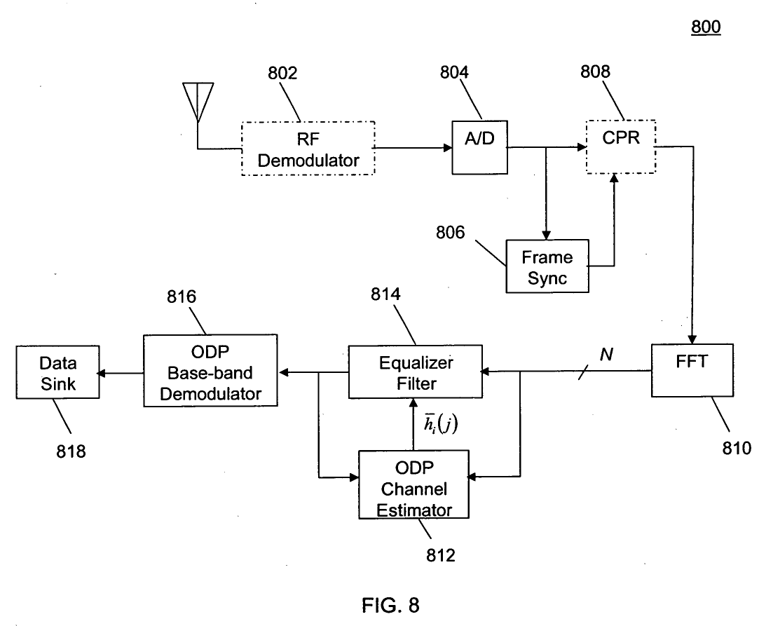

FIG. 8 shows a simplified block diagram of OFDM receiver 800 according to one embodiment of the present invention. Receiver 800 comprises RF demodulator 802, analog-to-digital (A/D) converter 804, and cyclic prefix remover (CPR) 808, which perform operations analogous to those of the equivalent processing of prior-art receiver 400 of FIG. 4. Note that if the transmitter does not employ cyclic prefix insertion and RF modulation, then CPR 808 and RF demodulator 802 are not required, respectively.

Frame synchronizer 806 establishes the timing for each OFDM frame. For OFDM signals that employ SYNC symbols (e.g., the embodiment of FIG. 7(b)), frame synchronizer 806 performs operations analogous to those of frame synchronizer 406 of prior-art receiver 400. For OFDM signals that do not employ SYNC symbols (e.g., the embodiment of FIG. 7(a)), frame synchronizer 806 computes the cross-correlation between the received signal samples and the pilot samples in each ODP OFDM symbol. The frame timing is determined by maximizing this cross-correlation over a period of time. The period of time is preferably between one to several frames in duration and may be selected based on factors such as the channel characteristics, the frame length, and the signal strength ratio between data components and the pilot components in the ODP OFDM symbols.

Similar to FFT processor 410, FFT processor 810 converts each time-domain ODP OFDM symbol i into a set of N frequency-domain complex numbers, where each complex number yᵢ(j) represents a received value corresponding to a frequency tone j. Each received value yᵢ(j) output by FFT processor 810 is represented by Equation (3) as shown below:

yᵢ(j)=sᵢ(j)hᵢ(j)+nᵢ(j), (3)

where hᵢ(j) is the channel gain, and nᵢ(j) is the channel noise. In each SYNC OFDM symbol i, sᵢ(j) represents the originally transmitted value that is known by the receiver. In each ODP OFDM symbol i, sᵢ(j) is equal to a data symbol value dᵢ(j) (i.e., sᵢ(j)=dᵢ(j)), a pilot symbol value pᵢ(j) (i.e., sᵢ(j)=pᵢ(j)), or a data symbol value dᵢ(j) plus a pilot symbol value pᵢ(j) (i.e., sᵢ(j)=dᵢ(j)+pᵢ(j)). Each pilot symbol value pᵢ(j) is known by the receiver; however, each data symbol value dᵢ(j) is not known by the receiver.

The received values yᵢ(j) are then demodulated by a data symbol demodulator which comprises channel gain estimator 812, equalizer filter 814, and base-band demodulator 816. Channel gain estimator 812 calculates a channel gain estimate h̅ᵢ(j) for each tone j of each OFDM symbol. Specifically, for each SYNC OFDM symbol i, the channel gain estimate h̅ᵢ(j) for each tone j may be calculated using Equation (4) as follows:

$${\overline{h}}_{i} ( j ) = \frac{{y}_{i} ( j )}{{s}_{i} ( j )} = {h}_{i} ( j ) + \frac{{n}_{i} ( j )}{{s}_{i} ( j )} . \qquad ( 4 )$$

Note that in embodiments that do not employ SYNC OFDM symbols (e.g., the embodiment of FIG. 7(a)), this calculation is not be performed. For each tone j of each ODP symbol i, channel estimator 812 calculates the channel gain estimate h̅ᵢ(j) using Equation (5) below:

h̅ᵢ(j)=α h̅ᵢ₋₁(j)+βĥᵢ(j), (5)

where α and β are predetermined constants. Estimate ĥᵢ(j) of Equation (5) can be calculated using multiple neighboring tone locations (a.k.a., a cluster).

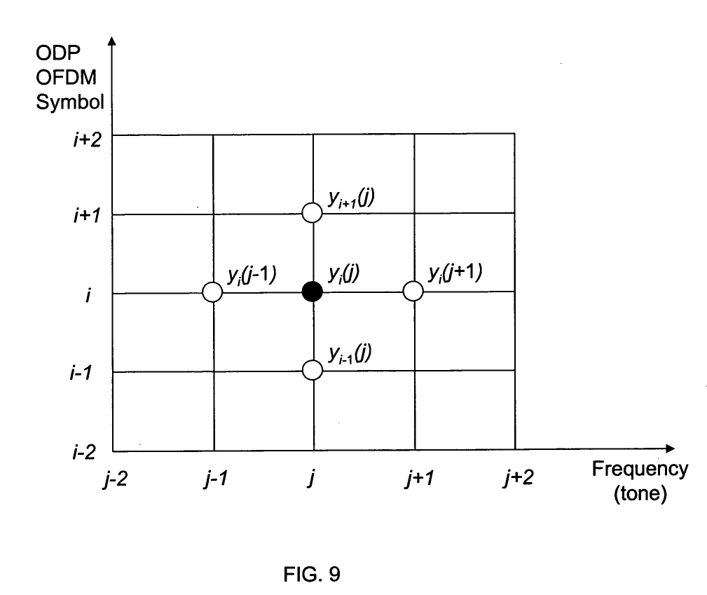

FIG. 9 graphically illustrates an exemplary cluster according to one embodiment of the present invention. The cluster of FIG. 9 shows a number C of tone locations equal to five, which are used to calculate estimate ĥᵢ(i) for received value yᵢ(j) (shown in black). The number C of tones in a cluster may be chosen such that the channel gain on each tone location within the cluster is approximately the same. Thus, in fast fading channels, tones that are close to the concerned tone may be chosen similar to the cluster shown in FIG. 9. In slow fading channels, the number C of tones in the cluster can be spread out. In FIG. 9, the cluster shown includes tones corresponding to received values yᵢ₋₁(j), yᵢ(j−1), yᵢ(j+1) and yᵢ₊₁(j). Depending on the channel properties, the cluster may be expanded on other tones further away from yᵢ(j).

Note that clusters near the first and last tone of an OFDM symbol may need to be modified. For example, if yᵢ(j) is the received value corresponding to the first tone of OFDM symbol i, then there would be no received value yᵢ(j−1) corresponding to the tone at OFDM symbol i, and tone j−1. The cluster in this example may be modified to eliminate this tone.

Similarly, clusters near the first and last OFDM symbols may also be modified. For example, if the ODP OFDM symbol is adjacent to a SYNC OFDM symbol, then tones of the SYNC OFDM symbol may be selected for the cluster. This may be particularly advantageous during initialization. Note that in embodiments that do not employ SYNC OFDM symbols (e.g., the embodiment of FIG. 7(a)), a value can be selected for channel gain estimate h̅ᵢ₋₁(j) of Equation (5) for initialization. For example, h̅ᵢ₋₁(j) can be selected to be equal to ĥᵢ(j).

Using the cluster, estimates ĥᵢ(j) of Equation (5) can be calculated using any one of a number of different methods. In one embodiment, estimate ĥᵢ(j) can be calculated as shown in Equation (6):

$${\hat{h}}_{i} ( j ) = [ \begin{matrix}{c}_{i} ( j ) \frac{{y}_{i} ( j )}{{p}_{i} ( j )} + {c}_{i + 1} ( j ) \frac{{y}_{i + 1} ( j )}{{p}_{i + 1} ( j )} + {c}_{i - 1} ( j ) \frac{{y}_{i - 1} ( j )}{{p}_{i - 1} ( j )} + \\ {c}_{i} ( j + 1 ) \frac{{y}_{i} ( j + 1 )}{{p}_{i} ( j + 1 )} + {c}_{i} ( j - 1 ) \frac{{y}_{i} ( j - 1 )}{{p}_{i} ( j - 1 )}\end{matrix} ] \qquad ( 6 )$$

where cᵢ(j), cᵢ₊₁(j), cᵢ₋₁(j), cᵢ(j+1), and cᵢ(j−1) are predefined constants allowing different weights for the different tone locations in the cluster. In this embodiment, the cluster is preferably selected such that each tone location within the cluster has either a pilot symbol or a known SYNC value. If the tone location is part of a SYNC OFDM symbol, the known tone value of the SYNC OFDM symbol shall replace the pilot value in Equation (6). In this case, the constant cᵢ(j) of the concerned tone can be increased so that the tone value of the SYNC OFDM symbol shall have a greater weight.

Referring again to FIG. 8, the channel gain estimates h̅ᵢ(j) from Equation (5) are then provided to equalizer filter 814 which performs operations analogous to equalizer filter 414 of prior-art receiver 400 to generate equalized values. The equalized values are then provided to base-band demodulator 816, which demodulates each equalized value using a standard or slightly modified constellation for each tone location. For example, if a data symbol was mapped to a constellation point on a QPSK constellation, the addition of the pilot symbol might not cause the new data/pilot symbol to deviate significantly from the standard QPSK constellation point. A slightly modified QPSK constellation may then be used to demodulate the data/pilot symbol without need to separate the data and pilot before demodulation. Base-band demodulator 816 then transmits likelihood estimates for each data symbol to data sink 818, which performs operations analogous to data sink 418.

By modulating pilot symbols onto tones with data symbols as shown in FIG. 6, the performance of the present invention can be improved over comparable prior-art OFDM systems. For example, when generating an OFDM symbol i based on the same number N of complex numbers as a prior-art transmitter, a transmitter according to the present invention can transmit more data symbols, thus increasing the throughput. Furthermore, by modulating pilot symbols onto tones with data symbols, channel estimation can be improved over prior-art OFDM systems. For example, when generating an OFDM symbol i based on the same number N of complex numbers and the same number D of data symbols as a prior-art transmitter, a transmitter according to the present invention can transmit more pilot symbols. The greater number of pilot symbols can then be used to improve channel estimation. Other implementations can be envisioned in which the number D of data symbols and the number P of pilot symbols are both partly increased such that data throughput is increased and channel estimation is improved over prior-art transmitters.

By reducing the SYNC OFDM symbols or by eliminating the SYNC OFDM symbols as shown in FIG. 7(a), further increases in performance can be achieved. Specifically, additional ODP symbols can be transmitted in place of the SYNC OFDM symbols. The additional ODP symbols increase the amount of data symbols and pilot symbols transmitted. The increase in data symbols can improve data through-put and the increase in pilot symbols can improve channel estimation over comparable prior-art systems.

According to various embodiments of the present invention, the transmitter may generate pilot symbols using any one of a number of methods commonly known in the art. For example, the pilot symbols may be obtained from a predetermined set of values in a look-up table (LUT). The pilot symbol values in the LUT may be repeated at regular intervals (e.g., repeated each frame), and thus, the LUT can be implemented using just one set of values.

Another example of a method for generating pilot symbols is suggested in FIG. 5. In this embodiment, the pilot symbols are generated from a stream of pseudorandom noise (PN) bits. As shown, pilot symbol generator 508 may comprise a PN bit sequence generator 520, an S/P converter 522, and a base-band modulator 524. PN sequence generator 520 generates a serial stream of PN bits that is known by the receiver. The serial stream of PN bits may be continuous or the stream may be repeated at regular intervals (e.g., repeated each frame). S/P converter 522 converts the serial stream of PN bits into P parallel bit streams. Base-band modulator 524 modulates each parallel bit stream into a separate pilot symbol stream. In particular, for each pilot symbol stream, base-band modulator 524 converts each set of one or more pilot bits into a frequency-domain pilot symbol represented as a complex number. Modulation is performed using any one of a number of techniques commonly known in the art, such as quadrature phase-shift-keying (QPSK) or quadrature amplitude modulation (QAM). The P parallel, frequency-domain pilot symbol streams are then provided to OFDM modulator 526.

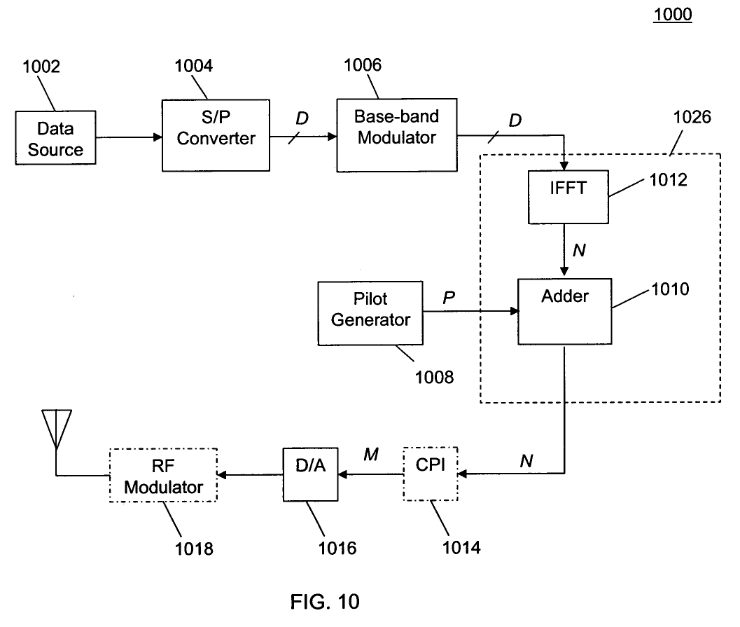

FIG. 10 shows a simplified block diagram of an OFDM transmitter 1000 according to another embodiment of the present invention. OFDM transmitter 1000 has steps of processing which are analogous to the steps of processing of transmitter 500. Note, however, that OFDM modulator 1026 has adder 1010 which is positioned downstream of IFFT processor 1012. Thus, each set of N frequency-domain complex numbers transformed by IFFT processor 1012 is based only on a set of D frequency-domain data symbols and possibly one or more guard tone locations (i.e., N=D+G).

For each set of N time-domain complex numbers generated by IFFT processor 1012, pilot generator 1008 generates a corresponding set of P time-domain pilot symbols, where the number P of pilot symbols is preferably equal to the number N of complex numbers. Pilot symbol generator 1008 may generate the P time-domain pilot symbols using any of a number of possible methods. For each corresponding pair of sets of N time-domain complex numbers and P time-domain pilot symbols, adder 1010 performs a sample-by-sample addition to produce a set of N time-domain complex numbers in which at least one time-domain complex number has both pilot and data. Note that since the operations performed by IFFT processing are linear, OFDM modulator 1026 of transmitter 1000 is capable of producing the same output as that of OFDM modulator 526 of transmitter 500. Therefore, transmitter 1000 is capable of producing any of the possible arrangements of pilot symbols and data symbols onto tones of an OFDM symbol described above (e.g., such as those in FIG. 6).

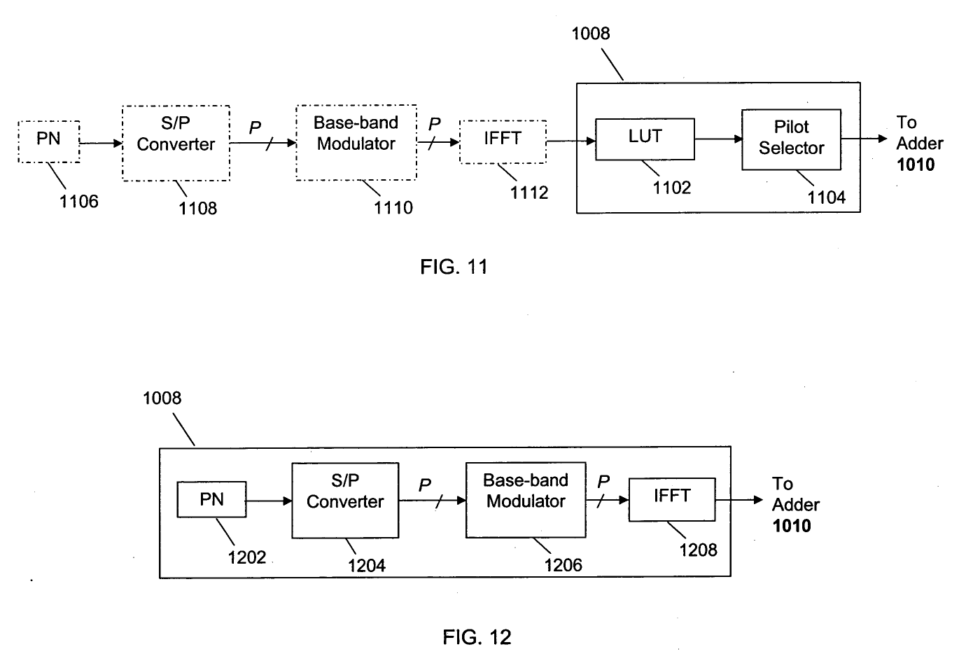

FIG. 11 shows a simplified block diagram of a pilot symbol generator 1008 that may be used by the OFDM transmitter 1000 of FIG. 10 to generate sets P time-domain pilot symbols according to one embodiment of the present invention. Pilot symbol generator 1008 has LUT 1102 which stores time-domain pilot symbol values. Pilot selector 1104 obtains the time-domain pilot symbols values from LUT 1102 and provides them to adder 1010. Note that for each pilot symbol value that will be assigned to the same tone as a data symbol value, the energy of the pilot symbol value may be scaled such that it is preferably significantly less than the energy of the data symbol value. Thus, adder 1010 may be a simple adder.

The time-domain pilot symbol values may be stored in LUT 1102 using any of a number of methods. For example, in one such method, the time-domain pilot symbol values may be programmed into LUT 1102. FIG. 11 suggests another such method in which the values in LUT 1102 are pre-computed off-line using PN bit sequence generator 1106, S/P converter 1108, and base-band modulator 1110 which perform operations analogous to those of the equivalent processing of pilot symbol generator 508 suggested in FIG. 5 to generate sets of P frequency-domain pilot symbols. Each set of P frequency-domain pilot symbols is then transformed off-line by IFFT processor 1112 into a set of P time-domain pilot symbols. The P time-domain pilot symbols are then provided to LUT 1102

FIG. 12 shows a simplified block diagram of a pilot generator that may be used by OFDM transmitter 1000 of FIG. 10 to generate sets P time-domain pilot symbols according to another embodiment of the present invention. According to this embodiment, pilot symbol generator 1008 has PN bit sequence generator 1202, S/P converter 1204, base-band modulator 1206, and IFFT processor 1208 which perform operations analogous to those of the equivalent processing suggested in FIG. 11 to generate sets of P time-domain pilot symbols. The sets of P time domain symbols are then provided directly to adder 1010.

According to further embodiments of the present invention, the receiver can calculate estimates ĥᵢ(j) of Equation (5) using likely data signal values for each tone in the cluster. For example, using the cluster of FIG. 9, the receiver can estimate the most likely data signal values d̅ᵢ(j), d̅ᵢ₊₁(j), d̅ᵢ₋₁(j), d̅ᵢ(j+1), and d̅ᵢ(j−1) corresponding to received values yᵢ(j), yᵢ₊₁(j), yᵢ₋₁(j), yᵢ(j+1), and yᵢ(j−1), respectively. Each likely data signal value can be calculated using an available channel gain estimate from a tone that is close in time and in frequency, assuming that the channel gain for the tone location is approximately the same. These data values can then be used to calculate estimate ĥᵢ(j) for received value yᵢ(j) as follows:

$${\hat{h}}_{i} ( j ) = [ \begin{matrix}{c}_{i} ( j ) \frac{{y}_{i} ( j ) - {\overline{d}}_{i} ( j ) {\overline{h}}_{i - 1} ( j )}{{p}_{i} ( j )} + \\ {c}_{i + 1} ( j ) \frac{{y}_{i + 1} ( j ) - {\overline{d}}_{i + 1} ( j ) {\overline{h}}_{i - 1} ( j )}{{p}_{i + 1} ( j )} + \\ {c}_{i - 1} ( j ) \frac{{y}_{i - 1} ( j ) - {\overline{d}}_{i - 1} ( j ) {\overline{h}}_{i - 1} ( j )}{{p}_{i - 1} ( j )} + \\ {c}_{i} ( j + 1 ) \frac{{y}_{i} ( j + 1 ) - {\overline{d}}_{i} ( j + 1 ) {\overline{h}}_{i - 1} ( j + 1 )}{{p}_{i} ( j + 1 )} + \\ {c}_{i} ( j - 1 ) \frac{{y}_{i} ( j - 1 ) - {\overline{d}}_{i} ( j - 1 ) {\overline{h}}_{i - 1} ( j - 1 )}{{p}_{i} ( j - 1 )}\end{matrix} ] \qquad ( 7 )$$

In Equation (7) the cluster may preferably be selected such that each tone location has a pilot value or a known SYNC value. Additionally, the likely data signal value for each tone location in the cluster that does not have data can be set to zero.

According to yet another embodiment of the present invention, the receiver can estimate ĥᵢ(j) of Equation (5) using the most likely data signal values as shown in Equation (8):

$${\hat{h}}_{i} ( j ) = [ \begin{matrix}{c}_{i} ( j ) \frac{{y}_{i} ( j )}{{p}_{i} ( j ) + {\overline{d}}_{i} ( j )} + \\ {c}_{i + 1} ( j ) \frac{{y}_{i + 1} ( j )}{{p}_{i + 1} ( j ) + {\overline{d}}_{i + 1} ( j )} + \\ {c}_{i - 1} ( j ) \frac{{y}_{i - 1} ( j )}{{p}_{i - 1} ( j ) + {\overline{d}}_{i - 1} ( j )} \\ {c}_{i} ( j + 1 ) \frac{{y}_{i} ( j + 1 )}{{p}_{i} ( j + 1 ) + {\overline{d}}_{i} ( j + 1 )} + \\ {c}_{i} ( j - 1 ) \frac{{y}_{i} ( j - 1 )}{{p}_{i} ( j - 1 ) + {\overline{d}}_{i} ( j - 1 )}\end{matrix} ] \qquad ( 8 )$$

In the Equation (8), the cluster may be preferably selected such that each tone location has a data symbol, a pilot symbol, or both a data symbol and a pilot symbol. If a tone location does not have a data symbol, then the likely data symbol value corresponding to the tone location may be set to zero. Similarly, if a tone location does not have a pilot symbol, then the likely pilot symbol value corresponding to the tone location may be set to zero.

Although the present invention has been described in terms of complex numbers, the present invention is not so limited. The term “complex number” as used in this application also includes cases when either the real part or the imaginary part of the complex number is equal to zero.

The present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments.

We claim:

1. A method for encoding data using orthogonal frequency division multiplexing (OFDM) modulation based on a set of OFDM tones, the method comprising:
(a) generating a set of one or more data symbol values;
(b) generating a set of one or more pilot symbol values; and
(c) applying OFDM modulation to the set of one or more data symbol values and the set of one or more pilot symbol values to generate an OFDM symbol in which at least one of the OFDM tones corresponds to both a data symbol value and a pilot symbol value.

2. The invention of claim 1, wherein the set of one or more pilot symbol values is generated from a sequence of pseudorandom noise data.

3. The invention of claim 1, wherein (e.g., FIG. 5) step (c) comprises:
(i) assigning, in a frequency domain, each data symbol value in the set of one or more data symbol values to a different one of the OFDM tones;
(ii) assigning, in the frequency domain, each pilot symbol value in the set of one or more pilot symbol values to a different one of the OFDM tones;
(iii) summing the data and pilot values for each OFDM tone that has both a data symbol value and a pilot symbol value assigned; and
(iv) transforming the set of OFDM tones to generate the OFDM symbol in a time domain.

4. The invention of claim 3, wherein for each OFDM tone that has both a data symbol value and a pilot symbol value assigned, step (c)(iii) comprises weighting at least one of the data symbol value and the pilot symbol value such that the data symbol value is greater than the pilot symbol value.

5. The invention of claim 1, wherein (e.g., FIG. 10) step (c) comprises:
(i) assigning, in a frequency domain, each data symbol value in the set of one or more data symbol values to a different one of the OFDM tones;
(ii) transforming the set of OFDM tones to generate an OFDM symbol in a time domain;
(iii) assigning, in the time domain, each pilot symbol value in the set of one or more pilot symbol values to a different OFDM tone in the OFDM symbol; and
(iv) summing the data and pilot values for each OFDM tone of the OFDM symbol that has both a data symbol value and a pilot symbol value assigned.

6. The invention of claim 5, wherein for each OFDM tone of the OFDM symbol that has both a data symbol value and a pilot symbol value assigned, step (c)(iv) comprises weighting at least one of the data symbol value and the pilot symbol value such that the data symbol value is greater than the pilot symbol value.

7. The invention of claim 1, wherein the method ensures that each OFDM tone that corresponds to a data symbol value also corresponds to a pilot symbol value.

8. The invention of claim 1, wherein:
steps (a)-(c) are implemented multiple times for different sets of data to generate one or more frames of OFDM symbols having no synchronization OFDM symbols;
at least one of the OFDM tones in each OFDM symbol corresponds to both a data symbol value and a pilot symbol value; and
further comprising:
(d) transmitting the one or more frames of OFDM symbols without transmitting any synchronization OFDM symbols.

9. An apparatus for generating an OFDM symbol based on a set of OFDM tones, the apparatus comprising:
(a) a data symbol generator (e.g., 502, 504, and 506) adapted to generate a set of one or more data symbol values;
(b) a pilot symbol generator (e.g., 508) adapted to generate a set of one or more pilot symbol values; and
(c) an OFDM modulator (e.g., 526) adapted to apply OFDM modulation to the set of one or more data symbol values and the set of one or more pilot symbol values to generate an OFDM symbol in which at least one of the OFDM tones corresponds to both a data symbol value and a pilot symbol value.

10. The invention of claim 9, wherein the pilot symbol generator generates the set of one or more pilot symbol values from a sequence of pseudorandom noise data.

11. The invention of claim 9, wherein the OFDM modulator comprises:
(1) an adder (e.g., 510) adapted to:
(i) assign, in a frequency domain, each data symbol value in the set of one or more data symbol values to a different one of the OFDM tones;
(ii) assign, in the frequency domain, each pilot symbol value in the set of one or more pilot symbol values to a different one of the OFDM tones;
(iii) sum the data and pilot values for each OFDM tone that has both a data symbol value and a pilot symbol value assigned; and
(2) a transformer (e.g., 512) adapted to transform the set of OFDM tones to generate the OFDM symbol in a time domain.

12. The invention of claim 11, wherein for each OFDM tone of the OFDM symbol that has both a data symbol value and a pilot symbol value assigned, the adder is adapted to weight at least one of the data symbol value and the pilot symbol value such that the data symbol value is greater than the pilot symbol value.

13. The invention of claim 9, wherein the OFDM modulator comprises:
(1) a transformer (e.g., 1012) adapted to:
(i) assign, in a frequency domain, each data symbol value in the set of one or more data symbol values to a different one of the OFDM tones; and
(ii) transform the set of OFDM tones to generate an OFDM symbol in a time domain; and
(2) an adder (e.g., 1010) adapted to:
(i) assign, in the time domain, each pilot symbol value in the set of one or more pilot symbol values to a different OFDM tone in the OFDM symbol; and
(ii) sum the data and pilot values for each OFDM tone of the OFDM symbol that has both a data symbol value and a pilot symbol value assigned.

14. The invention of claim 13, wherein for each OFDM tone of the OFDM symbol that has both a data symbol value and a pilot symbol value assigned, the adder is adapted to weight at least one of the data symbol value and the pilot symbol value such that the data symbol value is greater than the pilot symbol value.

15. The invention of claim 9, wherein the apparatus ensures that each OFDM tone that corresponds to a data symbol value also corresponds to a pilot symbol value.

16. A method (e.g., FIG. 8) for decoding a time-domain OFDM symbol having a set of OFDM tones, the method comprising:
(a) applying OFDM demodulation to the time-domain OFDM symbol to recover one or more frequency-domain demodulated symbol values encoded in the OFDM symbol, wherein at least one frequency-domain demodulated symbol value corresponds to both a data symbol value and a pilot symbol value; and
(b) recovering one or more data values from the one or more frequency-domain demodulated symbol values.

17. The invention of claim 16, wherein step (b) comprises:
(i) estimating, based on the one or more frequency-domain demodulated symbol values, the channel gain of one or more OFDM tones in the set of OFDM tones to generate one or more channel gain estimates; and
(ii) equalizing the one or more frequency-domain demodulated symbol values using the one or more channel gain estimates to generate the one or more equalized symbol values.
(iii) applying base-band demodulation to the one or more equalized symbol values to recover the one or more data values.

18. The invention of claim 17, wherein step (i) comprises generating at least one of the channel gain estimates using the frequency-domain demodulated symbol value for at least one neighboring tone located within the same OFDM symbol.

19. The invention of claim 17, wherein step (i) comprises generating at least one of the channel gain estimates using the frequency-domain demodulated symbol value for at least one neighboring tone located within at least one neighboring OFDM symbol.

20. The invention of claim 17, wherein step (i) comprises generating at least one of the channel gain estimates using the frequency-domain demodulated symbol value for at least one neighboring tone located within at least one neighboring OFDM symbol and the frequency-domain demodulated symbol value for at least one neighboring tone located within the same OFDM symbol.

21. The invention of claim 16, further comprising determining OFDM symbol timing by computing a cross-correlation between samples of the time-domain OFDM symbol and known pilot symbol values

22. The invention of claim 16, comprising:
receiving one or more frames of time-domain OFDM symbols, each frame having no synchronization OFDM symbols; and
applying steps (a) and (b) to each received time-domain OFDM symbol, wherein at least one frequency-domain demodulated symbol value recovered from each OFDM symbol corresponds to both a data symbol value and a pilot symbol value.

23. An apparatus for recovering data from a time-domain OFDM symbol having a set of OFDM tones, the apparatus comprising:
(1) an OFDM demodulator (e.g., 810) adapted to apply OFDM demodulation to the time-domain OFDM symbol to recover one or more frequency-domain demodulated symbol values encoded in the time-domain OFDM symbol, wherein at least one frequency-domain demodulated symbol value corresponds to both a data symbol value and a pilot symbol value; and
(2) a data symbol demodulator (e.g., 812, 814, 816) adapted to recover the one or more data values from the one or more frequency-domain demodulated symbol values.

24. The invention of claim 23, wherein the data symbol demodulator comprises:
(i) a channel estimator (e.g., 812) adapted to estimate, based on the one or more frequency-domain demodulated symbol values, the channel gain of one or more OFDM tones in the set of OFDM tones to generate one or more channel gain estimates;
(i) an equalizer (e.g., 814) adapted to equalize the one or more frequency-domain demodulated symbol values using the one or more channel gain estimates to generate the one or more equalized symbol values.
(3) a base-band demodulator (e.g., 816) adapted to apply base-band demodulation to the one or more equalized symbol values to recover the one or more data values.

25. The invention of claim 24, wherein the channel estimator is adapted to generate at least one of the channel gain estimates using the frequency-domain demodulated symbol value for at least one neighboring tone located within the same OFDM symbol.

26. The invention of claim 24, wherein the channel estimator is adapted to generate at least one of the channel gain estimates using the frequency-domain demodulated symbol value for at least one neighboring tone located within at least one neighboring OFDM symbol.

27. The invention of claim 24, wherein the channel estimator is adapted to generate at least one of the channel gain estimates using the frequency-domain demodulated symbol value for at least one neighboring tone located within at least one neighboring OFDM symbol and the frequency-domain demodulated symbol value for at least one neighboring tone located within the same OFDM symbol.
